(19) United States
(12) Patent Application Publication
(10) Pub. No.: US 2016/0171414 A1
(43) Pub. Date: Jun. 16, 2016

(54) Method for Creating an Intelligent Energy KPI System

(71) Applicant: Saudi Arabian Oil Company, Dhahran (SA)

(72) Inventor: Shuyee Lee, Abqaiq Community (SA)

(21) Appl. No.: 14/567,713

(22) Filed: Dec. 11, 2014

(51) Int. Cl. G06Q 10/06

(52) U.S. Cl. CPC G06Q 10/06393

(57) ABSTRACT

The present disclosure describes methods and systems, including computer-implemented methods, computer-program products, and computer systems, for creating an intelligent energy KPI system. Real-time data is received including information from a plurality of equipment modules. The real-time data is validated and reconciled. Based on a determination that a particular equipment module of the plurality of equipment modules is running, a key performance indicator (KPI) value and target KPI value is calculated for the particular equipment module. An upward integration is performed to populate the KPI value and target KPI value throughout hierarchical levels of a modular hierarchical structure of modules representing elements of an industrial complex. Based on a determination that a KPI violation exists, a downward integration is performed to identify an equipment module that is the most significant contributor to the KPI violation. Possible root causes for the KPI violation are identified and displayed.

### BACKGROUND

Key performance indicators (KPIs) are widely used in the process industry to improve efficiency. For example, a KPI for energy can be defined as energy consumption per unit of production. A KPI can be affected by several factors. For example, energy consumption in an industrial complex can be strongly affected by production volume, change in feedstocks, product specifications, equipment availability, and/or other factors. Furthermore, a given organization or facility can have several relevant KPIs and it can be important to define a small number of KPIs that are closely aligned with the organization's goals and objectives. Accordingly, a vast amount of raw data scattered across the entire organization or facility may have to be monitored, processed, and consolidated into a few KPI values/targets, which makes it extremely difficult to uncover operational intelligence such as problem(s), root cause(s), and corrective action(s) from the vast amount of data to remedy a particular KPI violation.

### SUMMARY

The present disclosure describes methods and systems, including computer-implemented methods, computer-program products, and computer systems for creating an intelligent energy KPI system. Real-time data is received including information from a plurality of equipment modules. The real-time data is validated and reconciled. Based on a determination that a particular equipment module of the plurality of equipment modules is running, a key performance indicator (KPI) value and target KPI value is calculated for the particular equipment module. An upward integration is performed to populate the KPI value and target KPI value throughout hierarchical levels of a modular hierarchical structure of modules representing elements of an industrial complex. Based on a determination that a KPI violation exists, a downward integration is performed to identify an equipment module that is the most significant contributor to the KPI violation. Possible root causes for the KPI violation are identified and displayed.

One computer-implemented method includes receiving real-time data including information from a plurality of equipment modules; validating and reconciling the real-time data; based on a determination that a particular equipment module of the plurality of equipment modules is running, calculating a key performance indicator (KPI) value and target KPI value for the particular equipment module; performing an upward integration to populate the KPI value and target KPI value throughout hierarchical levels of a modular hierarchical structure of modules representing elements of an industrial complex; based on a determination that a KPI violation exists, performing a downward integration to identify an equipment module that is the most significant contributor to the KPI violation; identifying possible root causes for the KPI violation associated with the identified equipment module; and initiating display of a possible root cause for the KPI violation.

Other implementations of this aspect include corresponding computer systems, apparatuses, and computer programs recorded on one or more computer-readable media/storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

The foregoing and other implementations can each optionally include one or more of the following features, alone or in combination:

A first aspect, combinable with the general implementation, wherein the real-time data includes at least one of flow rates, temperatures, pressures, levels, valve open/closed status, or pump running/stopped status.

A second aspect, combinable with any of the previous aspects, comprising processing the real-time data to permit extraction of operational intelligence from the real-time data.

A third aspect, combinable with the general implementation, wherein, for the particular equipment module, the target KPI value is calculated in real-time using a KPI baseline model.

A fourth aspect, combinable with any of the previous aspects, comprising setting status indicators based on a comparison of the KPI value and the target KPI value.

A fifth aspect, combinable with the general implementation, comprising collecting historical and current data for the equipment module to analyze for KPI violation root causes.

A sixth aspect, combinable with any of the previous aspects, comprising determining the number of possible root causes for the KPI violation associated with the identified equipment module.

The subject matter described in this specification can be implemented in particular implementations so as to realize one or more of the following advantages. First, the intelligent KPI energy system and method described in this disclosure can generate intelligent information automatically from data analysis in real-time. Second, users with little or no process background can easily and efficiently receive the intelligent information and advice. This can enable users with different disciplines to proactively engage in energy efficiency improvement activities. Third, the system can identify the most significant problem(s) and root cause(s) and can provide a recommendation to address inefficiency issues. In this manner, a user can simply follow the recommendation to make an improvement. Fourth, one or more of the most significant equipment, modules, or root causes can be identified. Fifth, decomposition of a large industrial complex into a hierarchical structure, built up from simple small equipment modules, can simplify an original large complicated problem to several small simple self-contained problems that can be managed easily. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an implementation of an example modular hierarchical structure used in an intelligent energy key performance indicator (KPI) system according to an implementation.

FIG. 2 illustrates a method to yield an intelligent energy KPI system according to an implementation.

FIG. 3 is a block diagram of an example computer used to implement an intelligent energy KPI system according to an implementation.

FIG. 4A is an example KPI baseline model for a piece of equipment to calculate real-time KPI targets for energy benchmarking according to an implementation.

FIG. 4B is an example equipment performance model of a piece of equipment comparing historical and predictive data according to an implementation.

FIG. 5 is a screenshot of an example KPI indication/status display according to an implementation.

Like reference numbers and designations in the various drawings indicate like elements.

### DETAILED DESCRIPTION

This disclosure generally describes methods and systems, including computer-implemented methods, computer-program products, and computer systems, for creating an intelligent energy KPI system.

The following description is presented to enable any person skilled in the art to make and use the invention, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Key Performance Indicators (KPIs) are widely used in the process industry to improve efficiency. For example, a KPI for energy can be defined as energy consumption per unit of production. A KPI can be affected by several factors. For example, energy consumption in an industrial complex can be strongly affected by production volume, change in feedstocks, product specifications, equipment availability, and/or other factors. Furthermore, a given organization or facility can have several relevant KPIs and it can be important to define a small number of KPIs that are closely aligned with the organization's goals and objectives. Therefore, it is challenging, for meaningful energy benchmarking purposes, to come up with appropriate energy KPI targets to reflect current plant operations. Accordingly, a vast amount of raw data scattered across the entire organization or facility may have to be monitored, processed, and consolidated into a few KPI values/targets, which makes it extremely difficult to uncover operational intelligence such as problem(s), root cause(s), and corrective action(s) from the vast amount of data to remedy a particular KPI violation.

Some energy KPI systems in the process industry provide visualization and drilldown tools/charts for users to monitor overall energy performance. However, the users must typically have process knowledge and familiarity with process integration and distributed control systems to understand KPI calculations. Sometimes, the users have to conduct time-consuming and labor-intensive investigation and root cause analysis to determine problem(s), root cause(s), and corrective action(s). Furthermore, it can be difficult to set a meaningful or efficient energy benchmark or energy target. Accordingly, it can be difficult to use such systems for proactive energy management and optimization to improve overall energy efficiency.

At a high level, this disclosure is drawn to a method for generating an intelligent energy KPI system based on modular engineering. The disclosure provides an example of a systematic way to structure a large industrial complex hierarchically, a method to monitor overall energy performance using a few KPIs from the highest level, to transform raw process data to operational intelligence at the lowest level, and to integrate the interconnected information throughout all hierarchical levels. For example, operational intelligence can be obtained through analysis of all relevant historical and current process data. The intelligent energy KPI system can determine proper KPI targets to reflect current plant operations and monitor/detect any energy KPI violations. When an energy KPI violation at the highest level is detected, the system can immediately identify the least energy-efficient operation or equipment, the root cause(s), and the corrective action(s) to efficiently remedy the energy inefficiency. For example, upon detection of a violation, the system can identify and communicate with an Operating Unit responsible for the corrective action. With such an intelligent energy KPI system, a traditional time-consuming root cause analysis and incident investigation is longer needed in essentially all cases. Improvements in energy efficiency are realized through quick response and full participation across the organization in energy-saving activities by following the actionable advice provided by the energy KPI system.

In some implementations, the above-described hierarchical structure of a large industrial complex can include, in decreasing order of hierarchy, Enterprise, Plant, Unit, and Equipment Modules. A KPI baseline model and an equipment performance model can be developed for each equipment module to facilitate energy benchmarking. Energy monitoring functionality at the highest level and operational intelligence at the lowest level can be integrated to yield an energy KPI system that can provide a high-level overview of plant-wide energy performance while identifying the most inefficient operation/equipment, root cause, and actionable advice to tackle any energy-inefficiency issues.

In some implementations, the disclosed intelligent energy KPI system can provide alarms only when an enterprise-level KPI is violated. In this manner, an entire organization can be focused on the most important KPIs and not by relatively minor energy-inefficient events. Therefore, time and resources can be used more efficiently to improve energy management.

Hierarchical Structure

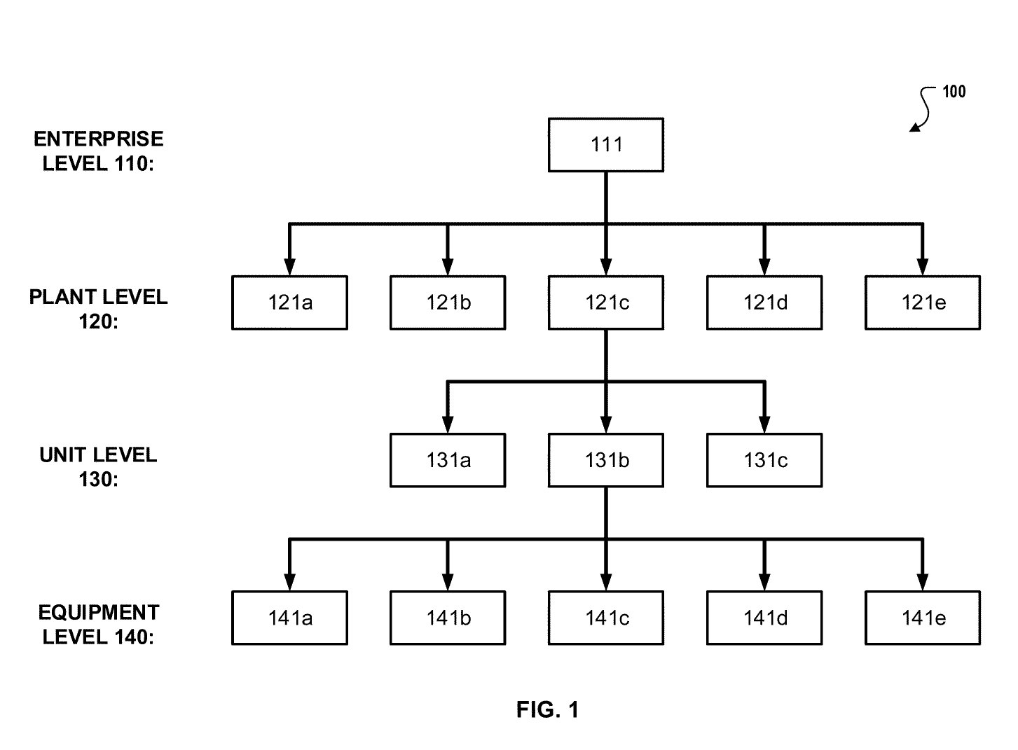

FIG. 1 illustrates an implementation of an example modular hierarchical structure 100 used in an intelligent energy KPI system according to an implementation. The example hierarchical structure 100 defines a decomposition of a large industrial complex built up from simple small modules (e.g., representing equipment) and can be organized into a tree-like structure, in which underlying interrelating information between different hierarchical levels is characterized by parent/child relationships between modules. For example, in the illustrated example of FIG. 1, each “parent” can have many “children” while each “child” has only one “parent.” In other implementations, other associative relationships may be possible (e.g., each “parent” can have many “children” and each “child” and have many “parents”).

In the example modular hierarchical structure 100, the modules are designated into four hierarchical levels: 110, 120, 130, and 140 corresponding to, respectively and in decreasing hierarchical order: Enterprise Level, Plant Level (Plants within the Enterprise Level), Unit Level (Units within the Plant Level), and Equipment Level (Equipment within the Unit Level). While in the modular hierarchical structure 100, four levels are described, in other implementations fewer or more levels can be used according to the particular needs and characteristics of the modular hierarchical structure, underlying industrial complex, and/or any other applicable criteria.

As illustrated, each hierarchical level (e.g., 110, 120, 130, and 140) contains one or more modules that can be associated with a module(s) at a higher/lower hierarchical level. For example, Enterprise module 111 is associated with multiple Plant modules 121a-e. Here, each Plant module 121a-e can, for example, represent individual Plants within an overall industrial complex that is represented by Enterprise module 111. As illustrated, example Plant module 121c is associated with multiple Unit modules 131a-c. Here, each Unit module can, for example, represent individual industrial process units within each Plant. As illustrated, example Unit module 131b is associated with multiple Equipment modules 141a-e. Here, each Equipment module can, for example, represent individual pieces of equipment within each Unit. For example, equipment modules 141a-e could represent, respectively, a low pressure (LP)/high-pressure (HP) LP/HP compressor, combin-air cooler, stripping column, de-ethanizer column, and refrigeration system. In this manner, an industrial complex can be organized and compartmentalized. While not illustrated, in other implementations, associations can jump between non-adjacent hierarchical levels. For example, Enterprise module 111 could be directly associated with Unit module 131a or a module at some other hierarchical level.

In some implementations, templates can be generated for different hierarchical structures, including different levels, modules, relationships, and/or combinations. For example, a set of Plants can each have similar hierarchical organization, so a single template could be used for each Plant in the set, with minor modifications as necessary (e.g., adding/removing Unit modules, Equipment modules, etc.). Using modular hierarchical structure 100 in another example, Equipment modules 141a and 141e could be derived from a first module template, and Equipment modules 141c and 141d could be derived from a second (and different) module template. In this manner, a hierarchical structure can be selected from a set of templates instead of being wholly generated for each application. In some implementations, each template can also include data, models, parameters, calculations, rules, logic, KPI data, and/or other information associated with modules in the template. In some implementations, module templates can be added to an organization's library and shared across the organization to improve efficiency and standardization.

Energy Benchmarking

In some implementations, energy benchmarking and operational intelligence can be generated, in part, from modules such as the above-described Equipment modules (141a-141e). For example, for each Equipment module, one or more KPI baseline models can be developed from historical data to calculate KPI baseline values and KPI targets. These KPI baseline values and KPI targets can correspond to current operating conditions or modes. In some implementations, data that represents the historically best performance (e.g., energy performance) are used for the model development. In some implementations, an energy KPI target can be set at a certain percentage (e.g., 107%, 110%, or another percentage) of the baseline value. In some implementations, a real-time KPI value can be calculated based on real-time data from an Equipment module. This real-time KPI data can be continuously calculated and monitored. Limiting a model to a single Equipment module can reduce model complexity, increase model accuracy, and/or allow the model to be more easily modified.

As an example, a baseline model can include a single-variable nonlinear regression curve analysis in which the Y-axis can represent a KPI value and the X-axis can represent a production rate. In some implementations, multivariate nonlinear regression models or multiple baseline models are used to calculate baseline values. For example, a module representing an Oil Stabilizer can include several baseline models corresponding to various stabilization levels of H₂S. Continuing in this example, the KPI system can read the real-time production and steam injection ratio of a particular stabilizer, use the steam injection ratio to determine a targeted stabilization level, select a corresponding baseline model, and then use the model to calculate KPI baseline and target values for the particular stabilizer. In other implementations, modules can represent other types of equipment, and use other type of calculations, models, etc.

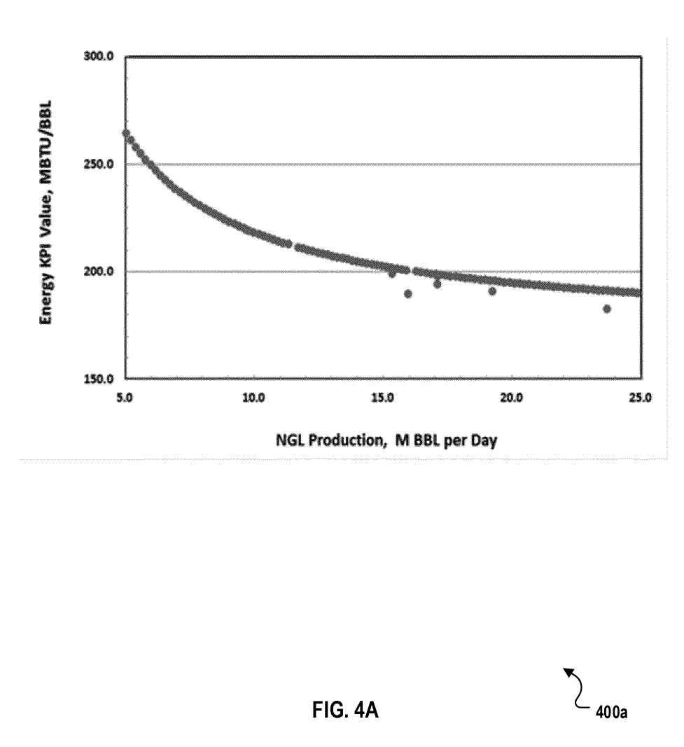

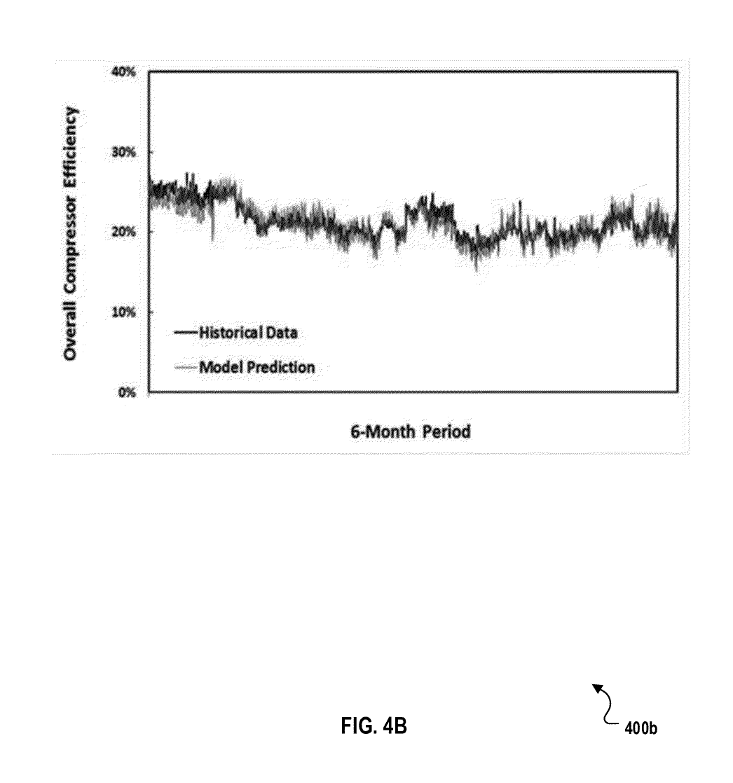

Turning to FIG. 4A, FIG. 4A is an example KPI baseline model 400a for a piece of equipment to calculate real-time KPI targets for energy benchmarking according to an implementation. Here the equipment is a LP/HP Compressor module, which can be represented by a single-variable nonlinear regression equation, as a function of a respective natural gas liquids (NGL) production rate through the equipment module.

FIG. 4B is an example equipment performance model 400b of a piece of equipment comparing historical and predictive data according to an implementation. The equipment performance model FIG. 4B is to calculate efficiency of a LP/HP Compressor module (e.g., that of FIG. 4A) at its healthy condition, which is then used to determine if poor energy performance is caused by operation—or equipment-related problems—part of operational intelligence. FIG. 4B exhibits good agreement between historical efficiency data and efficiency values predicted by an equipment performance model for the LP/HP Compressor module. Here the equipment performance model can be represented by a multivariate nonlinear regression equation, which can be a function of LP compression ratio, HP compression ratio, LP actual gas flow rate, HP actual gas flow rate, and compressor rotation speed.

Upward Integration

Returning to FIG. 1, following the method and system described herein, real-time KPI values and targets for equipment modules can be calculated that are consistent with current operating conditions or modes. In some implementations, information related to modules in a certain level can be merged with information related to modules in a hierarchically higher level (“upward integration”). As an example, information related to energy benchmarking at a first lowest level in the hierarchy (e.g., the Equipment modules 141a-e in FIG. 1) can be merged hierarchically upward to a next higher second level (e.g., Unit modules 131a-c in FIG. 1). Information related to the second level can then be merged upward into a higher third level, and so on.

For example, KPI information related to Equipment modules 141a-e can be merged additively to generate KPI information related to Unit module 131b. This can be described by the following equation:

KPI_{[UNIT B]}=KPI_{[EQUIPMENT A]}+KPI_{[EQUIPMENT B]}+KPI_{[EQUIPMENT C]}+KPI_{[EQUIPMENT D]}+KPI_{[EQUIPMENT E]}.

In another example, the Unit modules 131a-c can be operated in parallel within Plant module 121c. Therefore, the KPI information related to Unit modules 131a-c can be merged as described in the following example equation (where Prod represents the production rate through a particular unit):

$${KPI}_{[ PLANT C ]} = \frac{\begin{matrix}{Prod}_{[ UNIT A ]} \times {KPI}_{[ UNIT A ]} + {Prod}_{[ UNIT B ]} \times \\ {KPI}_{[ UNIT B ]} + {Prod}_{[ UNIT C ]} \times {KPI}_{[ UNIT C ]}\end{matrix}}{{Prod}_{[ UNIT A ]} + {Prod}_{[ UNIT B ]} + {Prod}_{[ UNIT C ]}} .$$

Using merging techniques such as those described above or other merging techniques, KPI information for some or all modules can be calculated from the lowest modules in the hierarchy. For example, KPI values and KPI targets can be calculated for all modules on all hierarchical levels. In some cases, the KPI values obtained from the upward integration can be verified with the KPI values calculated by energy input/output through an appropriate energy balance boundary.

Downward Integration

In some implementations, the KPI information can be used to determine a relevant source of energy inefficiency. For example, a module can have a KPI value that exceeds some target or threshold. In some cases, multiple modules at different hierarchical levels can have energy inefficiencies. These multiple inefficiencies can contribute to an overall (e.g., Enterprise-level) inefficiency. In some implementations, energy monitoring requirements can be “downwardly” determined at the highest level downward to the lowest level to extract practical operational intelligence for improving overall energy efficiency of the enterprise (“downward integration”).

An example strategy is to select the most significant lower-level KPI violation based on certain criteria. For example, criteria can include the single module contributing most to the energy inefficiency, the single module deviating most from its target, and/or the single module with a maximum combination of inefficiency and deviation. Respective example equations are given below (where w₁ and w₂ represent weighting factors):

$$Max ( Energy Inefficiency ) = Max [ ( {KPI}_{Value} - {KPI}_{Target} ) \times Respective Flow ]$$

$$Max ( KPI Deviation ) = Max ( \frac{{KPI}_{Value} - {KPI}_{Target}}{{KPI}_{Target}} )$$

$$Max [ {w}_{1} \times ( Energy Inefficiency ) + {w}_{2} \times ( KPI Deviation ) ] .$$

Weighting factors are estimated values indicating the relative importance or impact of each item in a group as compared to the other items in the group. The purpose of assigning weighting factors is to help establish work/criterion priorities. The weighting factors are typically in the range of 0-1 and are typically manually set and fine-tuned to give satisfactory results. For example, if w1=1 and w2=0, the most significant lower-level KPI violation would be solely based on the one contributing most to the energy inefficiency, and vice versa. Here, the weighting factors w₁ and w₂ can be set to indicate the relative importance or impact of Energy Inefficiency versus KPI Deviation.

As an example with reference to FIG. 1, the Plant module contributing the most significantly to a KPI violation at the Enterprise module 111 can first be determined as Plant module 121c. Then, the Unit module contributing the most significantly can be determined as Unit module 131b. Then the Equipment module contributing the most significantly can be determined as Equipment module 141a. Therefore, the most significant contributor to an Enterprise-level energy inefficiency can be traced to specific equipment. This information can be used by the system to improve efficiency. For example, the system can determine an Operating Unit that is best suited to fix a problem with equipment in a specific Equipment module and notify one or more users/operators of the issue to address.

In some implementations, the system can include a representation of a hierarchical structure or portion of a hierarchical structure to assist a user. For example, any equipment KPI violation can be highlighted by orange or red status color, whereas good energy performance can be indicated by green or yellow status color. In some instances, a grey color can be reserved for equipment not running, for which KPI value and target are set to 0. In some implementations, the system can include other information, such as drilldown charts and tables to show KPI values, KPI targets, and status colors of all hierarchical levels, or other information such as audio cues/alarms. In this manner, a user can more easily and quickly focus on the Plant, Unit, and Equipment Modules with certain colors or other indicators.

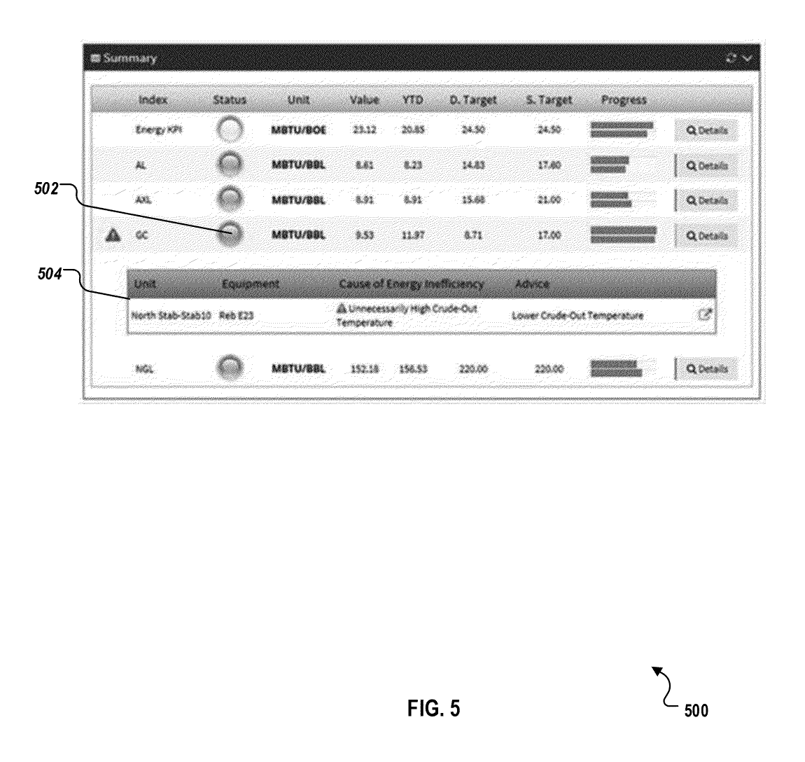

For example, turning to FIG. 5, FIG. 5 is a screenshot 500 of an example KPI indication/status display according to an implementation. In the example, on detecting a gas condensate (CG) energy KPI violation (502), the intelligent system automatically identifies information 504 associated with the CG energy KPI violation 502:

| | | |
|---|---|---|
| Operations responsible | North Stab | (i.e., North Stabilizers Plant) |
| Unit responsible | Stab 10 | (i.e., Stabilizer 10, Unit Operations) |
| Equipment responsible | Reb E23 | (i.e., Reboiler E23, Equipment) |

| | |
|---|---|
| Root Cause | Unnecessarily High Crude-Out Temperature |
| Corrective Action | Lower Crude-Out Temperature |

Note that other energy KPIs (e.g., Arabian Light (AL), Arabian Extra Light (AXL), and NGL) have no KPI violation and thus show green or yellow color without identifying the root cause.

Operational Intelligence

Returning to FIG. 1, in some implementations, once the equipment or module responsible for a significant contribution to a KPI violation is identified, all relevant historical and current data for this particular equipment or module can be collected and analyzed to identify the most significant root cause and corrective action. In some cases, in-depth time-series data analysis can be very time consuming and require a lot of computational resources, and thus can be impractical for a large industrial complex. The modular approach disclosed here requires data only for a relatively small/limited area (e.g., specific equipment or modules) and not the entire complex. This can make it possible to perform rigorous time-series data analysis online (without the need to invest/maintain high performance computing equipment), which can result in more accurate and timely intelligence information. Energy benchmarking and operational intelligence can be built up from bottom-level equipment modules. Specifically, for each equipment module, at least one equipment performance model can be developed from historical data or from original equipment manufacture's data to evaluate the equipment performance and then determine if the equipment energy KPI violation is caused by operations- or equipment-related problems.

As an illustrative example using a “LP/HP Compressor” module, different criteria can be used to assess energy efficiency. For example, the criterion used to assess the equipment performance is overall compressor efficiency, which is a function of the LP compression ratio, HP compression ratio, LP actual gas flow rate, HP actual gas flow rate, and compressor rotation speed. Regression techniques such as multivariate nonlinear regression techniques can be employed to produce a semi-empirical correlation model for compressor efficiency based on these factors. For example, for a “LP/HP Compressor” KPI violation, the compressors themselves are likely the culprit when the real-time compressor efficiency has been consistently below an expected healthy efficiency threshold as predicted by the compressor efficiency model and no obvious operations-related problems are/have been identified.

Different root causes can also be identified for a specific equipment module. The most significant root cause and corrective action can be determined by a rule-based expert system combined with rigorous time-series data analysis. For example, Table 1 below lists possible root causes and corrective actions that can be identified for the example “LP/HP Compressor” module by an example rule-based expert system.

TABLE 1

| No. | Root Cause | Corrective Action |
|---|---|---|
| 1 | Blowdown Valve Not Closed | Close Blowdown Valve |
| 2 | LP Recycle Valve Not Closed | Close LP Recycle Valve |
| 3 | HP Recycle Valve Not Closed | Close HP Recycle Valve |
| 4 | Unnecessarily High Compressor | Reduce Compressor Speed to |
| | Speed | Save Energy |
| 5 | Abnormally Low Compressor | Balance Load Among |
| | Load | Compression Trains |
| 6 | Abnormally High Inlet/Inter-Stage | Start More Fin Fans or Reduce |
| | Temp | Compressor Load |
| 7 | Poor Turbine/Compressor | Request Maintenance on |
| | Performance | Turbine/Compressor |
| 8 | No Obvious Root Cause Identified | Check Process Measurements |
| | | and PI Data |

In the example Table 1, Items 1-6 are related to equipment operations, which, if identified, can be quickly addressed by operators. Item 7 is tied to the equipment itself, and can be determined from the equipment performance model described above along with heuristic rules. Item 7 cannot be quickly fixed and requires maintenance services. Item 8 is used when the expert system and data analysis do not detect anything abnormal, and further analysis may be needed. Once a root cause and an associated corrective action can be identified from the in-depth data analysis, the newly identified root cause/corrective action can be easily incorporated into the system by adding new heuristic rules along with proper criteria for time-series data analysis. As will be apparent to those of ordinary skill, Table 1 is only one possible set of root causes and associated corrective actions and is presented to help with understanding and is not intended to be limiting in any way.

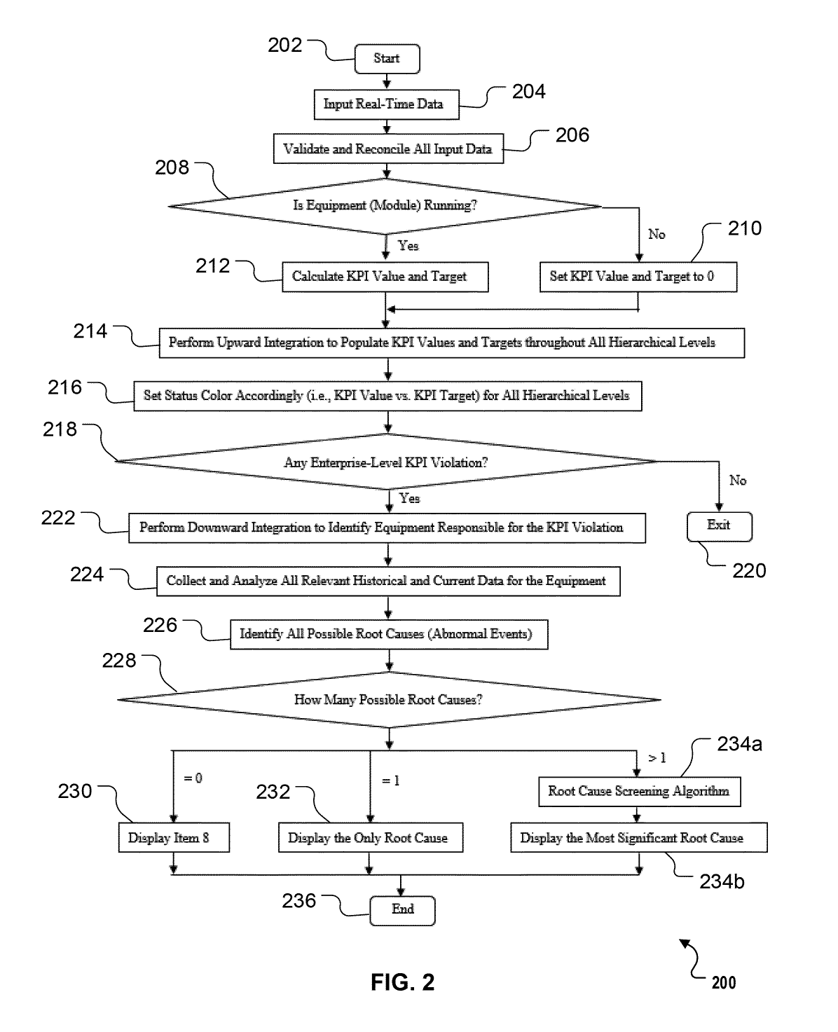

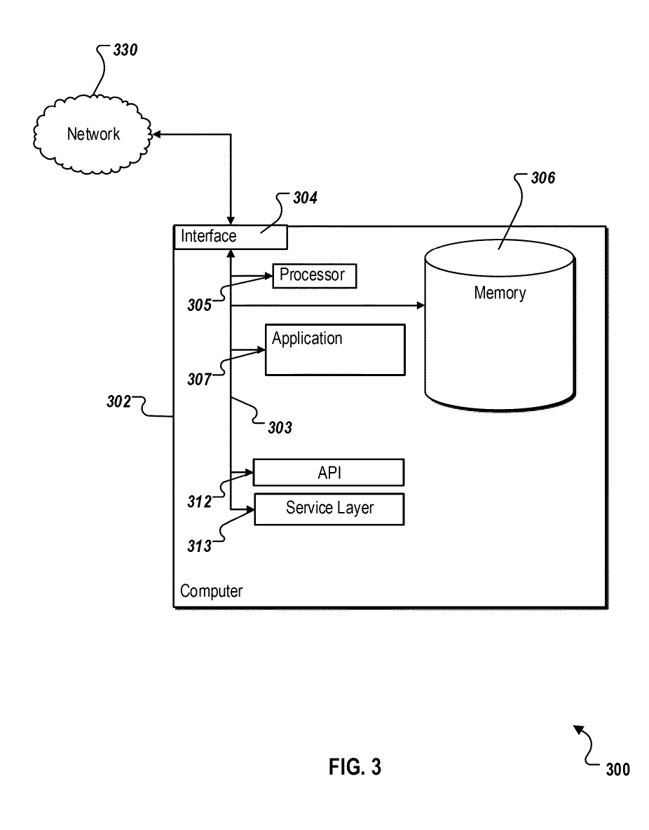

FIG. 2 illustrates a method 200 to yield an intelligent energy KPI system according to an implementation. For clarity of presentation, the description that follows generally describes method 200 in the context of FIGS. 1 and 3. However, it will be understood that method 200 may be performed, for example, by any other suitable system, environment, software, and hardware, or a combination of systems, environments, software, and hardware as appropriate. In some implementations, various steps of method 200 can be run in parallel, in combination, in loops, and/or in any order.

In some implementations, method 200 can be used to analyze efficiency and provide root-cause analysis. In some implementations, method 200 can be implemented to execute periodically (e.g., every 5 minutes, every 10 minutes, etc.). Note that for this particular example, only one root cause is displayed to avoid the need for user discretion. However, if desirable, multiple root causes can also be displayed.

At 202, method 200 starts. In some implementations, pre-processing, initialization, notifications, and/or other appropriate functions/actions can be performed at 202. From 202, method 200 proceeds to 204.

At 204, real-time raw data/information is received by the system at 204. For example, the real-time raw data/information can include information from equipment (modules). The raw data/information can include operating conditions (e.g., flow rates, temperatures, pressures, levels, etc.), modes, valve open/closed status, pump running/stopped status, and/or other information. The raw data is further processed in the KPI system to yield efficiency data, production rates, KPI values, KPI targets, and other current/historical information so operational intelligence can be extracted from the originally raw data. From 204, method 200 proceeds to 206.

At 206, the input data is validated and reconciled. Data validation and reconciliation ensures the program operates on clean, correct and useful data. Associated algorithms conduct data type validation, minimum/maximum range validation, rate of change validation (to reject noisy and frozen signals), and uses last known good data and/or other correlated/reconciled data in place of poor-quality data in the calculation/logic. From 206, method 200 proceeds to 208.

At 208, the running condition of a piece of equipment (module) is checked. If the equipment (module) is not running, the method proceeds to 210, in which the KPI value and KPI target can be set to a value of zero. If the equipment (module) is running, the method proceeds to 212.

At 212, a KPI value and KPI target is calculated for the equipment (module). The KPI value is calculated directly from raw data in real time while the KPI target is calculated from earlier-described KPI baseline model using real-time raw data as inputs (e.g., using the above-described techniques and/or other techniques). From 212, method 200 proceeds to 214.

At 214, upward integration (as described above) is performed to populate all hierarchical levels with KPI values and KPI targets. From 214, method 200 proceeds to 216.

At 216, modules at all hierarchical levels can be evaluated to determine an energy efficiency of that module. In some implementations, each module (or level) can be designated with a status indicator (e.g., a color, number, tag, flag, and/or other indicator) that reflects its energy efficiency. For example, a module or level for which the KPI value exceeds its KPI target can be designated with a red color on a display, and a module or level that is at or below its KPI target can be designated with a yellow or green color on the display. From 216, method 200 proceeds to 218.

At 218, the highest level of the hierarchical structure (e.g., the Enterprise Level) is evaluated to determine if a KPI violation is present at that level. If no KPI violation is present at that level, method 200 ends at 220. In some implementations, the method 200 can then begin again at 202. In some implementations, post-processing, finalization, notifications, and/or other appropriate functions/actions can be performed at 220. If a KPI violation is present, method 200 proceeds to 222.

At 222, a downward integration (as described above) is performed to identify equipment that is the most significant contributor to the determined KPI violation. From 222, method 200 proceeds to 224.

At 224, relevant data (e.g., historical and current data) is collected and analyzed for the identified equipment. From 224, method 200 proceeds to 226.

At 226, all possible root causes (or abnormal events) are identified for the equipment. Note that the identification can be based, in part, on the data collected and analyzed at 224. From 226, method 200 proceeds to 228.

At 228, the possible root causes are determined. If zero possible root causes are found, method 200 proceeds to 230 where information can be presented indicating as such. For example, using Table 1 above, method 200 could present Item 8 (No Obvious Root Cause Identified) along with its associated corrective action (Check Process Measurements and, for example, PLANT INFORMATION (PI) SYSTEM (by OSISOFT) data—or other like data). From 230, method 200 proceeds to 236.

If, however, a single root cause is found, method 200 proceeds to 232 and can initiate display of (e.g., present) information related to that single root cause. For example, a description of the root cause, a relevant Operating Unit assigned to fix the problem, and/or other information. From 232, method 200 proceeds to 236.

If, however, more than one root cause is found, method 200 proceeds to 234a. At 234a, method 200 can use techniques or algorithms to identify the most significant root cause. In some implementations at 234a, method 200 uses time series analysis techniques, which can be either time domain or frequency domain methods, to analyze all time series data (e.g., KPI values, temperatures, pressures, flows, etc.) relevant to this particular inefficient operation/equipment. For example, statistical dependence between any two random variables/events (e.g., KPI values and temperature values) can be determined by Pearson's correlation coefficient. Then, the most significant root cause can be identified based on the magnitude of calculated Pearson's correlation coefficients. From 234a, method 200 proceeds to 234b. At 234b, method 200 can initiate display of information related to the most significant root cause. Method 200 can also initiate display of information related to a set of most significant root causes. From 234b, method 200 proceeds to 236.

At 236, method 200 ends. In some implementations, post-processing, finalization, notifications, and/or other appropriate functions/actions can be performed at 236.

FIG. 3 is a block diagram 300 of an exemplary computer 302 used in the EDCS 100 according to an implementation. The illustrated computer 302 is intended to encompass any computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. Additionally, the computer 302 may comprise a computer that includes an input device, such as a keypad, keyboard, touch screen, or other device that can accept user information, and an output device that conveys information associated with the operation of the computer 302, including digital data, visual and/or audio information, or a GUI.

The computer 302 can serve as a client (e.g., client 102), network component, a server, a database or other persistency, and/or any other component of the EDCS 100. The illustrated computer 302 is communicably coupled with a network 330 (e.g., the network 130 of FIG. 1). In some implementations, one or more components of the computer 302 may be configured to operate within a cloud-computing-based environment.

At a high level, the computer 302 is an electronic computing device operable to receive, transmit, process, store, or manage data and information associated with the EDCS 100. According to some implementations, the computer 302 may also include or be communicably coupled with an application server, e-mail server, web server, caching server, streaming data server, business intelligence (BI) server, and/or other server.

The computer 302 can receive requests over network 330 from a client application (e.g., executing on another computer 302) and responding to the received requests by processing the said requests in an appropriate software application. In addition, requests may also be sent to the computer 302 from internal users (e.g., from a command console or by other appropriate access method), external or third-parties, other automated applications, as well as any other appropriate entities, individuals, systems, or computers.

Each of the components of the computer 302 can communicate using a system bus 303. In some implementations, any and/or all the components of the computer 302, both hardware and/or software, may interface with each other and/or the interface 304 over the system bus 303 using an application programming interface (API) 312 and/or a service layer 313. The API 312 may include specifications for routines, data structures, and object classes. The API 312 may be either computer-language independent or dependent and refer to a complete interface, a single function, or even a set of APIs. The service layer 313 provides software services to the computer 302 and/or the EDCS 100. The functionality of the computer 302 may be accessible for all service consumers using this service layer. Software services, such as those provided by the service layer 313, provide reusable, defined business functionalities through a defined interface. For example, the interface may be software written in JAVA, C++, or other suitable language providing data in extensible markup language (XML) format or other suitable format. While illustrated as an integrated component of the computer 302, alternative implementations may illustrate the API 312 and/or the service layer 313 as stand-alone components in relation to other components of the computer 302 and/or EDCS 100. Moreover, any or all parts of the API 312 and/or the service layer 313 may be implemented as child or sub-modules of another software module, enterprise application, or hardware module without departing from the scope of this disclosure.

The computer 302 includes an interface 304. Although illustrated as a single interface 304 in FIG. 3, two or more interfaces 304 may be used according to particular needs, desires, or particular implementations of the computer 302 and/or EDCS 100. The interface 304 is used by the computer 302 for communicating with other systems in a distributed environment—including within the EDCS 100—connected to the network 330 (whether illustrated or not). Generally, the interface 304 comprises logic encoded in software and/or hardware in a suitable combination and operable to communicate with the network 330. More specifically, the interface 304 may comprise software supporting one or more communication protocols associated with communications such that the network 330 or interface's hardware is operable to communicate physical signals within and outside of the illustrated EDCS 100.

The computer 302 includes a processor 305. Although illustrated as a single processor 305 in FIG. 3, two or more processors may be used according to particular needs, desires, or particular implementations of the computer 302 and/or the EDCS 100. Generally, the processor 305 executes instructions and manipulates data to perform the operations of the computer 302. Specifically, the processor 305 executes the functionality for creating/operating an intelligent energy KPI system.

The computer 302 also includes a memory 306 that holds data for the computer 302 and/or other components of the EDCS 100. Although illustrated as a single memory 306 in FIG. 3, two or more memories may be used according to particular needs, desires, or particular implementations of the computer 302 and/or the EDCS 100. While memory 306 is illustrated as an integral component of the computer 302, in alternative implementations, memory 306 can be external to the computer 302 and/or the EDCS 100.

The application 307 is an algorithmic software engine providing functionality according to particular needs, desires, or particular implementations of the computer 302 and/or the EDCS 100, particularly with respect to functionality required for creating an intelligent energy KPI system. For example, application 307 can serve as one or more components, modules, applications, etc. described with respect to FIGS. 1-2. Further, although illustrated as a single application 307, the application 307 may be implemented as multiple applications 307 on the computer 302. In addition, although illustrated as integral to the computer 302, in alternative implementations, the application 307 can be external to the computer 302 and/or the EDCS 100.

There may be any number of computers 302 associated with, or external to, the EDCS 100 and communicating over network 330. Further, the term “client,” “user,” and other appropriate terminology may be used interchangeably as appropriate without departing from the scope of this disclosure. Moreover, this disclosure contemplates that many users may use one computer 302, or that one user may use multiple computers 302.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus,” “computer,” or “electronic computer device” (or equivalent as understood by one of ordinary skill in the art) refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
receiving real-time data including information from a plurality of equipment modules;
validating and reconciling the real-time data;
based on a determination that a particular equipment module of the plurality of equipment modules is running, calculating a key performance indicator (KPI) value and target KPI value for the particular equipment module;
performing an upward integration to populate the KPI value and target KPI value throughout hierarchical levels of a modular hierarchical structure of modules representing elements of an industrial complex;
based on a determination that a KPI violation exists, performing a downward integration to identify an equipment module that is the most significant contributor to the KPI violation;
identifying possible root causes for the KPI violation associated with the identified equipment module; and
initiating display of a possible root cause for the KPI violation.

2. The method of claim 1, wherein the real-time data includes at least one of flow rates, temperatures, pressures, levels, valve open/closed status, or pump running/stopped status.

3. The method of claim 1, comprising processing the real-time data to permit extraction of operational intelligence from the real-time data.

4. The method of claim 1, wherein, for the particular equipment module, the target KPI value is calculated in real-time using a KPI baseline model.

5. The method of claim 1, comprising setting status indicators based on a comparison of the KPI value and the target KPI value.

6. The method of claim 1, comprising collecting historical and current data for the equipment module to analyze for KPI violation root causes.

7. The method of claim 1, comprising determining the number of possible root causes for the KPI violation associated with the identified equipment module.

8. A non-transitory, computer-readable medium storing computer-readable instructions, the instructions executable by a computer and configured to:
receive real-time data including information from a plurality of equipment modules;
validate and reconciling the real-time data;
based on a determination that a particular equipment module of the plurality of equipment modules is running, calculate a key performance indicator (KPI) value and target KPI value for the particular equipment module;
perform an upward integration to populate the KPI value and target KPI value throughout hierarchical levels of a modular hierarchical structure of modules representing elements of an industrial complex;
based on a determination that a KPI violation exists, perform a downward integration to identify an equipment module that is the most significant contributor to the KPI violation;
identify possible root causes for the KPI violation associated with the identified equipment module; and
initiate display of a possible root cause for the KPI violation.

9. The medium of claim 8, wherein the real-time data includes at least one of flow rates, temperatures, pressures, levels, valve open/closed status, or pump running/stopped status.

10. The medium of claim 8, comprising instructions to process the real-time data to permit extraction of operational intelligence from the real-time data.

11. The medium of claim 8, wherein, for the particular equipment module, the target KPI value is calculated in real-time using a KPI baseline model.

12. The medium of claim 8, comprising instructions to set status indicators based on a comparison of the KPI value and the target KPI value.

13. The medium of claim 8, comprising instructions to collect historical and current data for the equipment module to analyze for KPI violation root causes.

14. The medium of claim 8, comprising instructions to determine the number of possible root causes for the KPI violation associated with the identified equipment module.

15. A system, comprising:
a memory;
at least one hardware processor interoperably coupled with the memory and configured to:
receive real-time data including information from a plurality of equipment modules;
validate and reconciling the real-time data;
based on a determination that a particular equipment module of the plurality of equipment modules is running, calculate a key performance indicator (KPI) value and target KPI value for the particular equipment module;
perform an upward integration to populate the KPI value and target KPI value throughout hierarchical levels of a modular hierarchical structure of modules representing elements of an industrial complex;
based on a determination that a KPI violation exists, perform a downward integration to identify an equipment module that is the most significant contributor to the KPI violation;
identify possible root causes for the KPI violation associated with the identified equipment module; and
initiate display of a possible root cause for the KPI violation.

16. The system of claim 15, wherein the real-time data includes at least one of flow rates, temperatures, pressures, levels, valve open/closed status, or pump running/stopped status.

17. The system of claim 15, configured to process the real-time data to permit extraction of operational intelligence from the real-time data.

18. The system of claim 15, wherein, for the particular equipment module, the target KPI value is calculated in real-time using a KPI baseline model.

19. The system of claim 15, configured to set status indicators based on a comparison of the KPI value and the target KPI value.

20. The system of claim 15, configured to:
collect historical and current data for the equipment module to analyze for KPI violation root causes; and
determine the number of possible root causes for the KPI violation associated with the identified equipment module.
